(19) United States
(12) Patent Application Publication
(10) Pub. No.: US 2007/0119941 A1
(43) Pub. Date: May 31, 2007

(54) Bar code scanner programming

(75) Inventor: Duanfeng He, South Setauket, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Symbol Technologies, Inc., Holtsville, NY (US)

(21) Appl. No.: 11/290,273

(22) Filed: Nov. 30, 2005

(51) Int. Cl. G06K 7/10

(52) U.S. Cl. 235/462.15

(57) ABSTRACT

A user generates a programming bar code or programming parameter file that encompasses all desired parameter settings. A batch of scanners is programmed by scanning the bar code or reading the parameter file to simplify and expedite the programming process.

### TECHNICAL FIELD

The invention relates generally to the field of bar code processing and more particularly to programmable bar code scanners that can operate in more than one mode.

### BACKGROUND

Indicia scanners are becoming more complicated to configure as their capabilities become more diverse. For any given application, a user must tailor the operating parameters to match the needs of the application. The parameters may include the enable status of dozens of indicia types including one or more parameters related to each enabled indicia type such as the minimum and maximum expected indicia lengths. The parameters may also include communication parameters including protocol, baud rate, handshaking and session related parameters such as continuous vs. triggered operation, decode lock-out time, and session timeout period.

Typically, scanners are provided from the factory with default parameter settings. To change the scanner settings the user scans one or more parameter setting or programming bar codes that are also provided with the scanner. Some of the programming bar codes set a single scanner parameter. Other scanner parameters require the scanning of multiple programming bar codes. For example, to program the session timeout time for some scanners, a “session timeout” programming parameter barcode must be scanned followed by scanning three separate bar codes each corresponding to a single numeric digit. It is obvious that with this process the time required to program a group of scanners can be rather significant. Programming many scanners to incorporate a single set of parameters is frequently required as most facilities employ a number of scanners of the same type and users at the facility expect them to all function identically. In some operations the same set of scanners may be programmed daily to operate as POS terminals during the day and to take inventory at night.

Another way that desired parameters are input into an indicia scanner is through the use of a program running on a computer that communicates with the connected scanner through a communications link. To program a scanner in this manner the scanner is physically connected to a computer, a few programming barcodes are scanned for establishing the correct communications protocol on the scanner, and a computer program is instructed to connect to the scanner. Once connected, the program provides the user with a set of choices, changeable by using the keyboard or mouse. Once changed, these parameters can be uploaded into the scanner. As a final step, the scanner may need to be restored to the original communications state, as the program that normally interfaces with the scanner may use a different communications protocol from the one used by the parameter setting program.

### SUMMARY

Enabling a user to generate a programming bar code or programming parameter file that encompasses all desired parameter settings simplifies and expedites the programming of multiple scanners.

A method, computer readable media that stores instructions for performing the method, and an apparatus that programs one or more bar code scanners is provided. An interface is provided through which scanner parameter settings can be input. The input parameter settings are received and encoded in a programming bar code. The programming bar code is scanned with the one or more bar code scanners to program them.

The programming bar code can be a two dimensional bar code that encodes all of the input parameter settings. The interface can be achieved by displaying a series of prompts or choices on a display. The programming bar code can be printed out for scanning by the scanners. The parameter settings can be encoded in a plurality of programming bar codes. The available scanner parameters can be determined by queries made to one of the scanners. Alternatively, a set of available scanner parameters can be stored so that the interface accesses the stored set of parameters.

Rather than encoding the scanner parameter values in a programming bar code, the set of input parameter settings can be stored in a computer memory. In this case, the one or more scanners are placed in communication with the computer memory. A program enabling bar code can be generated or provided with the one or more scanners to place the one or more scanners in a programming mode. The set of available scanner parameters can be determined by queries made to one of the scanners. Alternatively, the set of available scanner parameters can be stored and wherein the interface accesses the stored set of parameters.

### BRIEF DESCRIPTION OF DRAWINGS

FIGS. 1 and 3 are schematic block diagrams of bar code scanner programming components arranged according to the present invention; and

FIGS. 2 and 4 are flowcharts outlining programming methods that can be use to program bar code scanners according to the present invention.

### DESCRIPTION

In the following detailed description, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

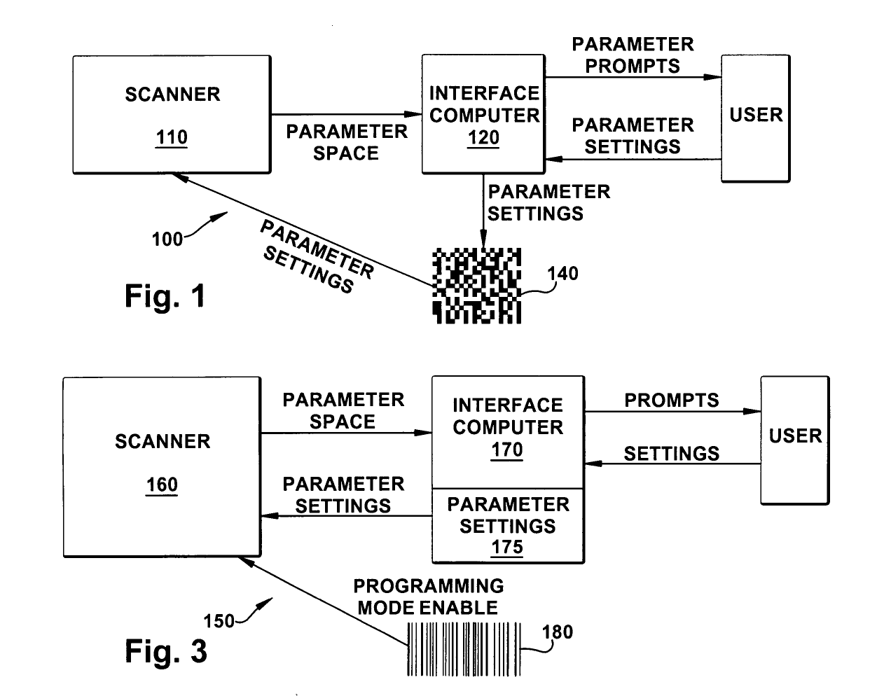

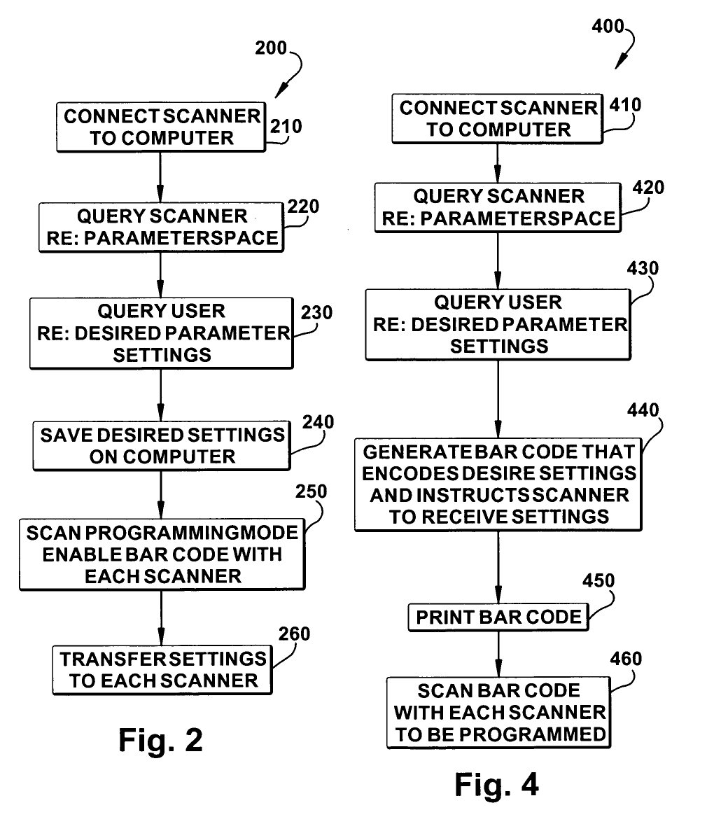

FIGS. 1 and 2 are directed to a method and configuration for programming scanners by way of a user generated bar code. The method is especially advantageous for scanners that can process 2 dimensional bar codes due to the large amount of data that can be encoded in such a 2-D bar code. It is likely that all of the information needed to program a bar code scanner can be encoded in a single 2-D bar code, however, one or more additional bar codes may be required for particularly complex bar code scanners and applications.

FIG. 1 shows a configuration of components 100 that can be used to program a batch of scanners using a 2-D programming bar code 140 that is generated and printed by a user. A scanner 110 is connected to an interface computer 120 that is accessed by a user to input parameters. The interface computer 120 is capable of printing one or more programming bar codes 140 that encode scanner parameter settings.

FIG. 2 outlines a method 200 that can be used to program a batch of scanners using the hardware configuration shown in FIG. 1. A scanner is connected to the interface computer at 210. The interface computer communicates with the scanner to determine the scanner's parameter space at 220. After this determination is made, the computer prompts the user to enter desired scanner parameter settings. The input settings are encoded in a 2-D bar code. The bar code is printed or displayed at 250 and scanners are programmed by scanning the bar code at 260.

It will be apparent to one of ordinary skill in the art that certain modifications to the described embodiment can be made. For example, the computer program may be equipped with the parameter spaces of many known types of scanners, therefore alleviating the need for the computer to extract this information from the scanner in steps 210 and 220. Including the steps 210 and 220 makes the computer program capable of functioning over a wider range of scanners including scanners designed in the future that have novel parameter spaces.

FIG. 3 shows a configuration of components 150 that can be used to program a batch of scanners that may not be capable of processing a 2-D programming bar code. A scanner 160 is connected to an interface computer 170 that is accessed by a user to input parameters. The interface computer 170 is capable of storing a set of scanner parameter settings that are input by the user in memory 175. The information received by the computer can be used to generate a one dimensional programming bar code that sets all the scanner settings necessary to enable the scanner to receive new settings. Alternatively, the programming bar code can be supplied with the scanner. This programming mode enable bar code 180, when scanned by a scanner, places the scanner in a programming mode in which the scanner can accept parameter settings from the computer 170. This single programming mode bar code compares advantageously to state of the art scanners, which require a separate programming bar code for each parameter of a single communications protocol, so because of the various modes the scanners may be in, a sequence of bar codes must be scanned to be certain to put the scanners in a mode in which it can receive a new set of parameter data.

FIG. 4 outlines a method 400 that can be used to program a batch of scanners using the hardware configuration shown in FIG. 3. A scanner is connected to the interface computer at 410. The interface computer communicates with the scanner to determine the scanner's parameter space at 420, which can be used to generate a one dimensional programming mode enable bar code. After this determination is made, the computer prompts the user to enter desired scanner parameter settings at 430. The input settings are stored in the computer and can be accessed directly by any further scanners that are connected to the computer at 440. To program all scanners a one dimensional programming mode enabling bar code which can be printed by the user or supplied with the scanner from the factory is scanned at 450 and at 460 the settings are transferred from the computer to the scanner when the user enters an appropriate command to the computer. The scanning of the programming mode enable bar code can take place before or after the scanner is connected to the computer.

As can be seen from the above description, enabling a set of multiple scanner parameters to be accessed at once by a scanner through the use of custom 2-D programming bar codes or programming files facilitates the programming of multiple scanners to incorporate the same settings. Although the present invention has been described with a degree of particularity, it is the intent that the invention include all modifications and alterations from the disclosed design falling within the spirit or scope of the appended claims.

I claim:

1. A method that programs one or more bar code scanners, the method comprising:
providing an interface through which scanner parameter settings can be input;
receiving the input parameter settings;
encoding the input parameter settings in a programming bar code;
scanning the programming bar code with the one or more bar code scanners.

2. The method of claim 1 wherein the programming bar code is a two dimensional bar code that encodes all of the input parameter settings.

3. The method of claim 1 wherein the interface is provided by displaying a series of choices on a display.

4. The method of claim 1 comprising printing out the programming bar code.

5. The method of claim 1 comprising encoding the parameter settings in a plurality of programming bar codes.

6. The method of claim 1 wherein the available scanner parameters are determined by queries made to one of the scanners.

7. The method of claim 1 including storing a set of available scanner parameters and wherein the interface accesses the stored set of parameters.

8. A method that programs one or more bar code scanners, the method comprising:
providing an interface through which scanner parameter settings can be input;
receiving a set of input parameter settings;
retaining the set of input parameter settings in a computer memory; and
placing the one or more scanners in communication with the computer memory.

9. The method of claim 8 comprising scanning a program enabling bar code with the one or more scanners to place the one or more scanners in a programming mode.

10. The method of claim 9 comprising generating the program enabling bar code that places the one or more scanners in a programming mode.

11. The method of claim 8 wherein the available scanner parameters are determined by queries made to one of the scanners.

12. The method of claim 8 including storing a set of available scanner parameters and wherein the interface accesses the stored set of parameters.

13. Computer readable media having computer executable instructions stored thereon for programming one or more bar code scanners, the instructions comprising:
providing an interface through which scanner parameter settings can be input;
receiving the input parameter settings; and
encoding the input parameter settings in a programming bar code.

14. The computer readable media of claim 13 wherein the programming bar code is a two dimensional bar code that encodes all of the input parameter settings.

15. The computer readable media of claim 13 wherein the instructions for providing an interface include displaying a series of choices on a display.

16. The computer readable media of claim 13 wherein the instructions include printing out the programming bar code.

17. The computer readable media of claim 13 wherein the instructions include encoding the parameter settings in a plurality of programming bar codes.

18. The computer readable media of claim 13 wherein the instructions include querying one of the scanners to determine the available scanner parameters.

19. The computer readable media of claim 13 wherein the instructions include storing a set of available scanner parameters and wherein the interface accesses the stored set of parameters.

20. Computer readable media having computer executable instructions for programming one or more bar code scanners, the instructions comprising:
providing an interface through which scanner parameter settings can be input;
receiving a set of input parameter settings;
retaining the set of input parameter settings in a computer memory; and
transferring the set input parameters to one or more scanners.

21. The computer readable media of claim 20 wherein the instructions include providing a program enabling bar code the scanning of which places the one or more scanners in a programming mode.

22. The computer readable media of claim 20 wherein the instructions include determining the available scanner parameters by querying one of the scanners.

23. The computer readable media of claim 20 wherein the instructions include storing a set of available scanner parameters and wherein the interface accesses the stored set of parameters.

24. The computer readable media of claim 21 wherein the instructions include generating the program enabling bar code that places the one or more scanners in a programming mode.

25. An apparatus that programs one or more bar code scanners, the apparatus comprising:
an interface through which scanner parameter settings can be input;
a bar code encoder that encodes the input scanner parameter settings in a programming bar code; and
a programming bar code generator that outputs the programming bar code.

26. The apparatus of claim 25 wherein the programming bar code is a two dimensional bar code that encodes all of the input parameter settings.

27. The apparatus of claim 25 wherein the interface includes a display that displays a series of choices.

28. The apparatus of claim 25 comprising a printer for printing out the programming bar code.

29. The apparatus of claim 25 wherein the interface queries one of the scanners to determine available scanner parameters.

30. The apparatus of claim 25 wherein the interface stores a set of available scanner parameters and wherein the interface accesses the stored set of parameters.

31. An apparatus that programs one or more bar code scanners, the method comprising:
an interface through which scanner parameter settings can be input;
memory for retaining the set of input parameter settings in a computer memory; and
a communication port for placing the one or more scanners in communication with the computer memory.

32. The apparatus of claim 31 comprising a program enabling bar code that encodes instructions to the one or more scanners to place the one or more scanners in a programming mode.

33. The apparatus of claim 31 including memory for storing a set of available scanner parameters in a data file and wherein the interface accesses the stored set of parameters.

34. An apparatus that programs one or more bar code scanners, the apparatus comprising:
means for providing an interface through which scanner parameter settings can be input; and
means for encoding the input parameter settings in a programming bar code;
means for outputting the programming bar code.
